(19) United States
(12) Patent Application Publication
(10) Pub. No.: US 2024/0371369 A1
(43) Pub. Date: Nov. 7, 2024

(54) TRANSCRIPT PAIRING

(71) Applicant: Origin8Cares, LLC, Lake Oswego, OR (US)

(72) Inventors: Geoffrey King, Montreal (CA); Daniel Craggs, Montreal (CA); Tamas Frajka, Hamburg (DE)

(21) Appl. No.: 18/654,140

(22) Filed: May 3, 2024

Related U.S. Application Data
(60) Provisional application No. 63/463,718, filed on May 3, 2023.

(51) Int. Cl. G10L 15/183; G10L 15/01; G10L 15/06; H04M 3/42

(52) U.S. Cl. CPC G10L 15/183; G10L 15/01; G10L 15/063; H04M 3/42221

(57) ABSTRACT

A machine-learned model receives an audio signal representing a spoken sequence of utterances for classification. The model repeatedly processes utterance pairs in a sequence of (u₀, u₁), (u₁, u₂), . . . (uₙ₋₁, uₙ) to generate prediction of target utterances. Each of the utterance pairs comprises a target utterance paired with another one of the utterances.

### CROSS-REFERENCE TO RELATED APPLICATIONS

This application claims the benefit of U.S. Provisional Patent Application No. 63/463,718, filed May 3, 2023, the entire disclosure of which is incorporated herein by reference.

### BACKGROUND

Applying standard Natural Language Processing (NLP) techniques that were developed for written language to transcripts of spoken conversations yields worse than expected results. Unlike written text, which is composed of complete and (for the most part) grammatically correct sentences, conversational transcripts are composed of utterances (the smallest unit of speech; continuous, beginning, and ending with a break). Such utterances are often incomplete statements and may not be grammatically correct on their own.

### SUMMARY

Aspects of the present disclosure inject the context of what an utterance is in response to in a conversation for improving NLP applied to transcripts of spoken conversations. Applying Machine Learning (ML) methods directly to these smaller units of text is the source of the problem that the subject matter of the present disclosure ameliorates.

In an aspect, a computer-implemented method for training a machine learning model comprises receiving an audio signal representing a spoken sequence of utterances, identifying one of the utterances as a target utterance to be transcribed, and defining an utterance pair for processing. The utterance pair, which comprises the target utterance paired with another one of the utterances, is processed with the machine-learned model to generate a prediction of the target utterance. The method also includes evaluating a loss function that compares the prediction to a ground truth value, and modifying one or more values of at least one parameter of the machine-learned model based at least in part on the evaluated loss function.

In another aspect, a computing system classifies a target utterance from an audio signal representing a spoken sequence of utterances. The computing system comprises one or more processors and one or more non-transitory computer-readable media storing a machine-learned model and computer-executable instructions. When executed by the one or more processors, the instructions cause the computing system to perform operations, which include receiving the audio signal representing the spoken sequence of utterances, identifying one of the utterances as the target utterance to be classified, and defining an utterance pair for processing. The utterance pair, which comprises the target utterance paired with another one of the utterances, is processed with the machine-learned model to generate a prediction of the target utterance that is then provided as an output.

In yet another aspect, a machine-learned transcription system comprises a telephony services receiving a spoken conversation between at least two persons and configured for recording the conversation. The recorded conversation comprises a spoken sequence of utterances. A speech to text service of the system is configured for transcribing the spoken sequence of utterances. The system further comprises a data builder service configured for identifying one of the transcribed utterances as a target utterance to be classified and defining an utterance pair for processing. The utterance pair comprises the target utterance paired with another one of the transcribed utterances. A machine learning engine of the system is configured for processing the utterance pair with a machine-learned model to generate a prediction of the target utterance and providing the prediction as an output.

Other objects and features of the present invention will be in part apparent and in part pointed out herein.

### BRIEF DESCRIPTION OF THE DRAWINGS

FIG. 1 is a block architectural diagram according to an embodiment.

FIG. 2 is a flow diagram illustrating an example process for transcript pairing according to an embodiment.

Corresponding reference characters indicate corresponding parts throughout the drawings.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

Aspects of the present disclosure inject the context of what an utterance is in response to in a conversation. For example, without context, a single utterance such as “okay” can have any number of meanings and interpretations, which degrades the accuracy of predictions from a machine learning model. By pairing it with the preceding utterance, the context of what it is in response to is added. By pairing it again with the following utterance, the context of what the statement prompts is also added. As a result, each utterance appears twice in the data sequence thus effectively doubling the amount of training data, which improves model training performance.

The process begins with a recording of a spoken conversation which is then transcribed into text using speech to text (STT) algorithms. The transcription process identifies the various speakers taking part in the conversation and segments the text into utterances labeled by the individual speaking. Training data for ML models is then constructed by creating alternating pairs of prompt and response utterances.

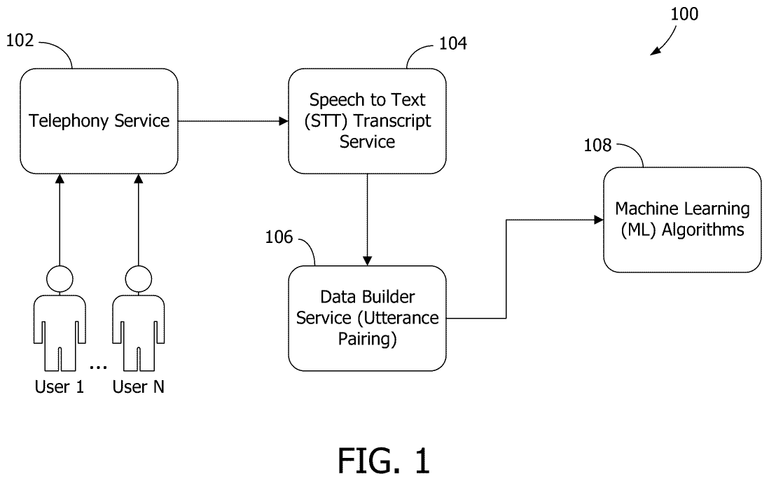

FIG. 1 illustrates and example architecture 100 embodying aspects of the present disclosure. A telephony service 102 records a conversation involving a plurality of users and produces a digital audio recording of the conversation. A speech to text (STT) service 104 transcribes the conversation recordings into textual form. The architecture 100 further includes a data builder service 106 configured for constructing utterance-pairs and manages the building of datasets from the utterance-pairs for processing by a machine learning (ML) engine 108. According to an embodiment, sentence embeddings of utterance-pairs are consumed in the training process of ML algorithms executed by the ML engine 108.

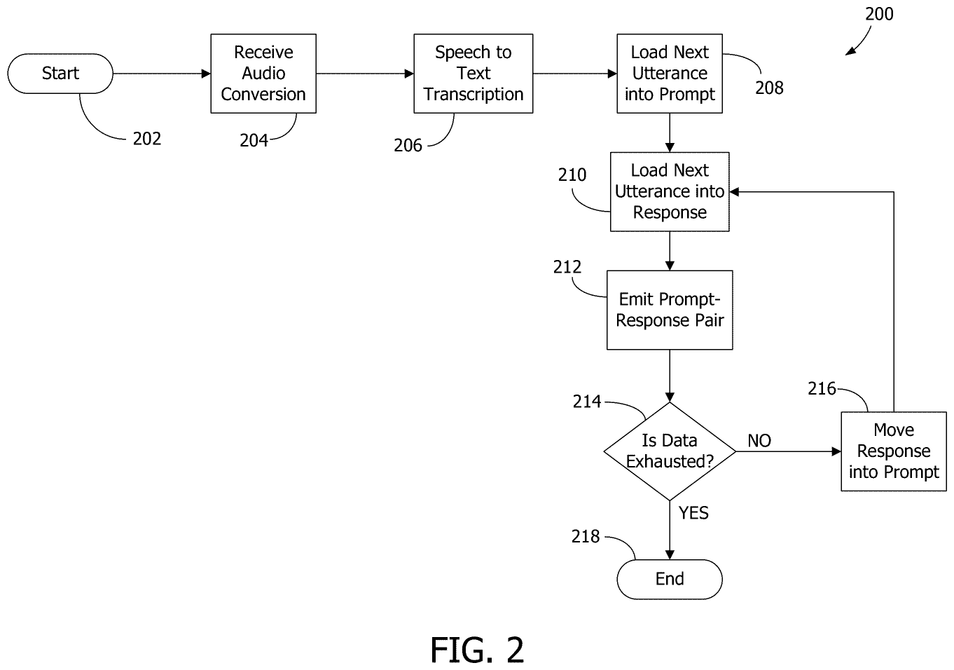

Referring now to FIG. 2, a process 200 for transcript pairing according to an embodiment begins at 202, initiated upon receipt of an audio file containing a recorded conversation. At 204, the audio file is processed by a speech to text algorithm executed by the STT service 104. The speech to text algorithm produces text grouped into utterances by the speaker. In an embodiment, the process of identifying different speakers and segmenting audio into utterances is done with the aid of statistical methods such as Gaussian Mixed Models and Hidden Markov Models.

The process 200 reads a leading utterance at 208 and uses it as the Utterance in a new Prompt Response pair. The process 200 then reads a trailing utterance from the alternate speaker and adds it as the response to the current Prompt-Response pair at 210. Pre-processing of utterances may include: Discarding utterances having low confidence scores indicating potential inaccuracies in transcription, as well as discarding utterances where the individual speaker could not be identified.

At 212, the completed Prompt-Response pair is emitted to the output data sequence. In an embodiment, complete prompt-response pairs in the output data sequence are transformed into vector representations using sentence-embedding models such as Bidirectional Encoder Representations from Transformers (BERT). Sentence embedding models are trained to learn contextual representations of words and sentences by predicting masked words and the relationship of sentence sequences.

At 214, the text of the transcript is checked to see if there are any remaining utterances to process. If so, a new Prompt-Response pair is created at 216 and process 200 returns to 210 for loading the next utterance. In this instance, the previous response utterance is used as the prompt in the next data pair. The process proceeds to 212 using the new data pair.

As shown, process 200 ends at 218 when the input transcript text does not have any utterances left to process, as indicated at 214.

Each utterance is used once as the prompt in a pair and as a response in another, creating the following data sequence:

$$\{ ( u 0 , u 1 ) , ( u 1 , u 2 ) , ... ( uk - 2 , uk - 1 ) , ( uk - 1 , uk ) \} .$$

As an example, the process 200 produces a sequence of prompt-response pairs from following transcript:
B: Oh hey there, are you having a nice day?
A: I am! How is the weather there?
B: Not so bad, but could be better.
A: Well, I hope you make the most of it, have a nice day!
B: Yes, and yourself.

The sequence of prompt-response pairs includes:
(“Oh hey there, are you having a nice day?”, “I am! How is the weather there?”);
(“I am! How is the weather there?”, “Not so bad, but could be better.”);
(“Not so bad, but could be better.”, “Well, I hope you make the most of it, have a nice day!”); and
(“Well, I hope you make the most of it, have a nice day!”, “Yes, and yourself.”).

Embodiments of the present disclosure may comprise a special purpose computer including a variety of computer hardware, as described in greater detail herein.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A computer-implemented method for training a machine learning model, comprising:
receiving an audio signal representing a spoken sequence of utterances;
identifying one of the utterances as a target utterance to be transcribed;
defining an utterance pair for processing, the utterance pair comprising the target utterance paired with another one of the utterances;
processing the utterance pair with the machine-learned model to generate a prediction of the target utterance;
evaluating a loss function that compares the prediction to a ground truth value; and
modifying one or more values of at least one parameter of the machine-learned model based at least in part on the evaluated loss function.

2. The computer-implemented method of claim 1, wherein the utterance paired with the target utterance immediately precedes the target utterance in the sequence of utterances.

3. The computer-implemented method of claim 1, wherein the utterance paired with the target utterance immediately follows the target utterance in the sequence of utterances.

4. The computer-implemented method of claim 1, further comprising repeatedly processing the utterance pair to create a rolling sequence of utterance pairs, the rolling sequence of utterance pairs comprising:
(u₀,u₁),(u₁,u₂), . . . (uₙ₋₁,uₙ).

5. The computer-implemented method of claim 1, further comprising executing a speech to text algorithm configured to transcribe the spoken sequence of utterances, and wherein the utterance pair for processing is defined from the transcribed sequence of utterances.

6. The computer-implemented method of claim 1, further comprising providing the prediction as an output.

7. A computing system for classifying a target utterance from an audio signal representing a spoken sequence of utterances, the computing system comprising:
one or more processors;
one or more non-transitory computer-readable media storing a machine-learned model for classifying the target utterance and computer-executable instructions that, when executed by the one or more processors, cause the computing system to perform operations, the operations comprising:
receiving the audio signal representing the spoken sequence of utterances;
identifying one of the utterances as the target utterance to be classified;
defining an utterance pair for processing, the utterance pair comprising the target utterance paired with another one of the utterances;
processing the utterance pair with the machine-learned model to generate a prediction of the target utterance; and
providing the prediction as an output.

8. The computing system of claim 7, wherein the utterance paired with the target utterance immediately precedes the target utterance in the sequence of utterances.

9. The computing system of claim 7, wherein the utterance paired with the target utterance immediately follows the target utterance in the sequence of utterances.

10. The computing system of claim 7, wherein the operations further comprise repeatedly processing the utterance pair to create a rolling sequence of utterance pairs, the sequence of utterance pairs comprising:
(u₀,u₁),(u₁,u₂), . . . (uₙ₋₁,uₙ).

11. The computing system of claim 7, wherein the operations further comprise executing a speech to text algorithm configured to transcribe the spoken sequence of utterances, and wherein the utterance pair for processing is defined from the transcribed sequence of utterances.

12. The computing system of claim 7, wherein the operations further comprise evaluating a loss function that compares the prediction to a ground truth value.

13. The computing system of claim 12, wherein the operations further comprise modifying one or more values of at least one parameter of the machine-learned model based at least in part on the evaluated loss function.

14. A machine-learned transcription system comprising:
a telephony services receiving a spoken conversation between at least two persons and configured for recording the conversation, the recorded conversation comprising a spoken sequence of utterances;
a speech to text service configured for transcribing the spoken sequence of utterances;
a data builder service configured for identifying one of the transcribed utterances as a target utterance to be classified and defining an utterance pair for processing, the utterance pair comprising the target utterance paired with another one of the transcribed utterances; and
a machine learning (ML) engine configured for processing the utterance pair with a machine-learned model to generate a prediction of the target utterance and providing the prediction as an output.

15. The machine-learned transcription system of claim 14, wherein the utterance paired with the target utterance immediately precedes the target utterance in the sequence of utterances.

16. The machine-learned transcription system of claim 14, wherein the utterance paired with the target utterance immediately follows the target utterance in the sequence of utterances.

17. The machine-learned transcription system of claim 14, wherein processing the utterance pair with the machine-learned model comprises repeatedly processing the utterance pair to create a rolling sequence of utterance pairs, the sequence of utterance pairs comprising:
(u₀,u₁),(u₁,u₂), . . . (uₙ₋₁,uₙ).

18. The machine-learned transcription system of claim 14, wherein the utterance pair for processing is defined from the transcribed sequence of utterances.

19. The machine-learned transcription system of claim 14, wherein processing the utterance pair with the machine-learned model comprises evaluating a loss function that compares the prediction to a ground truth value.

20. The machine-learned transcription system of claim 19, wherein processing the utterance pair with the machine-learned model further comprises modifying one or more values of at least one parameter of the machine-learned model based at least in part on the evaluated loss function.
